(19) United States
(12) Patent Application Publication
(10) Pub. No.: US 2026/0065803 A1
(43) Pub. Date: Mar. 5, 2026

(54) System

(71) Applicant: Softbank Group Corp, Tokyo (JP)

(72) Inventor: Masaki Hamada, Tokyo (JP)

(21) Appl. No.: 19/317,072

(22) Filed: Sep. 2, 2025

(30) Foreign Application Priority Data
Sep. 4, 2024 (JP) 2024-152622

(51) Int. Cl. G09B 19/00; G06F 3/01; G06F 16/438; H04N 21/81

(52) U.S. Cl. CPC G09B 19/0015; G06F 3/011; G06F 16/438; H04N 21/8113; H04N 21/816

(57) ABSTRACT

A system includes a processor that is configured to receive information regarding a dance style, age, physical ability, and preference from a user, analyze the received information and generate an original dance video and music based on an existing dance database, and transmit the generated original dance video and music to a user terminal.

### CROSS-REFERENCE TO RELATED APPLICATION

This application is based on and claims priority under 35 USC 119 from Japanese Patent Application No. 2024-152622 filed on Sep. 4, 2024, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional dance learning systems are limited in their ability to provide personalized choreography and tailored feedback for users with different physical abilities, preferences, and group configurations. Furthermore, there is a lack of efficient technology that can generate original dance routines and associated music automatically, as well as provide real-time motion analysis and corrective guidance for both individuals and groups.

### SUMMARY

To address these problems, the present invention provides a system including a processor configured to receive user information such as dance style, age, physical ability, and preferences, analyze this input to generate an original dance video and music based on a dance database, and transmit these to a user terminal. The processor further acquires motion data from wearable devices in real time, compares the data with the generated dance routines, and provides guidance and feedback for user movement correction through the wearable devices. Additionally, the system supports multiple users, generating integrated group choreographies and providing individual and group feedback to improve overall performance.

“Processor” means a central processing unit or computational device executes instructions and controls the processing of data within the system.

“User” means an individual who interacts with the system to receive personalized dance content and feedback.

“Dance style” means a genre or category of dance, such as hip-hop, jazz, ballet, or contemporary, which characterizes the choreography.

“Age” means the chronological stage of life of the user, considered in system customization to ensure appropriateness of the dance routine.

“Physical ability” means the user's degree of physical strength, flexibility, mobility, and endurance relevant to performing dance routines.

“Preference” means the user's individual likes, dislikes, or specific requests regarding music, choreography, style, or difficulty.

“Wearable device” means a sensor-equipped electronic device designed to be worn on the user's body for real-time motion data acquisition.

“Motion data” means sensor-derived information describing the user's body movements, joint positions, and kinematic parameters during dance practice.

“Dance database” means a collection of stored digital data containing information about various dance styles, choreographies, and associated music.

“Original dance video” means a newly generated visual representation of a dance routine, created based on user parameters and database content.

“Music” means an audio file or composition that accompanies the generated dance video, tailored to the user's specified preferences and style.

“User terminal” means an electronic device such as a smartphone, tablet, or personal computer operated by the user for system interaction.

“Group dance performance” means a coordinated dance routine designed for multiple users to perform together, with individualized roles.

“Choreography part” means a specific segment or set of dance movements allocated to an individual member within a group dance routine.

“Feedback” means information, guidance, or corrections provided to the user or group to improve dance performance and technique.

“Guidance” means real-time or post-practice instructions delivered to the user for adjusting movements and enhancing learning effectiveness.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

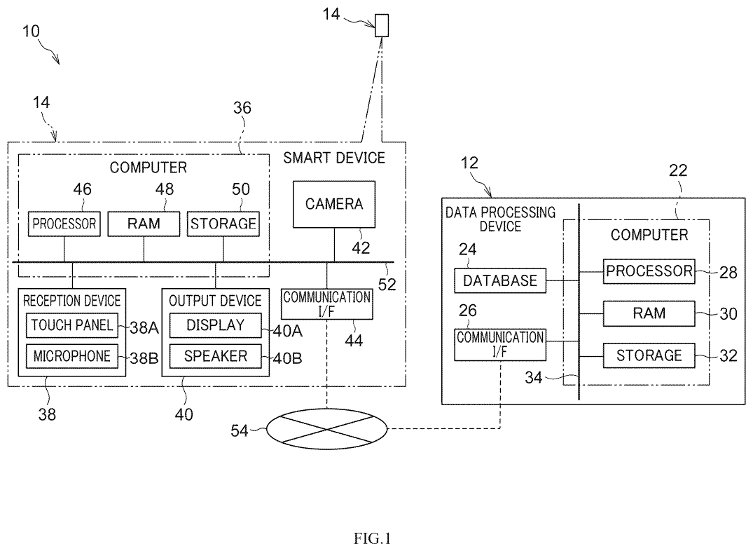

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

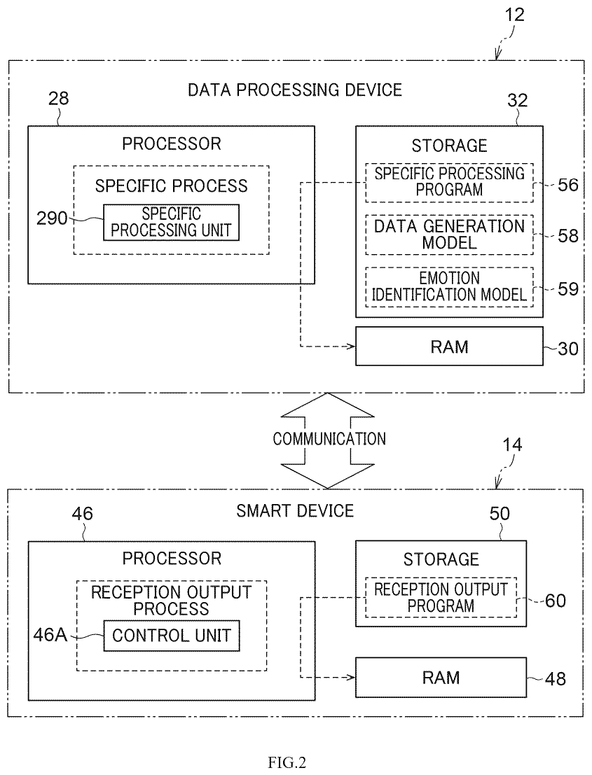

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

In recent years, the demand for dance as a means of entertainment or health maintenance has increased. However, it is difficult for individuals to find dance styles and choreography suitable for their attributes, such as age, physical condition, and personal preferences. Furthermore, receiving personalized feedback and effective practice guidance typically requires the intervention of professional instructors, which results in significant time and cost burdens. In the case of group dance performances, adjustments for group dynamics and individual instructions are also necessary, presenting additional challenges to efficient learning and skill improvement. There is a need for a system that automatically provides personalized dance routines and real-time, individualized feedback for both solo and group dance practice, thereby improving the efficiency, accessibility, and effectiveness of dance learning.

The specific processing by the specific processing unit 290 of the data processing device 12 in Example 1 is realized by the following means.

The present invention provides a server including a processor configured to receive attribute information and preference information from a user, generate a prompt sentence based on the attribute information and preference information, generate original motion data and acoustic data using a generative artificial intelligence model based on the prompt sentence and data stored in a data storage device, transmit the generated original motion data and acoustic data to an information processing terminal via a data communication device, record user interaction obtained from the information processing terminal, obtain biometric motion information in real time from a body information acquisition device worn by the user, analyze the obtained biometric motion information and video information to specify difference information by comparing with the generated original motion data, provide specific guidance and feedback to the user based on the difference information, and, for multiple users, allocate individual motion parts, perform group motion evaluation, and provide optimized feedback to both the group and individual members based on results of the group motion evaluation.

This enables the automated creation of tailored dance content and real-time, AI-driven corrective feedback for both individual and group users, thereby enhancing the efficiency and quality of dance practice and learning without the need for direct instructor involvement.

The term “attribute information” refers to information related to a user's characteristics, such as age, physical condition, or skill level.

The term “preference information” refers to data indicating a user's likes, dislikes, or desired features, such as preferred dance styles or music types.

The term “prompt sentence” refers to a generated instruction or textual query that is input to a generative artificial intelligence model to request the creation of dance and music content.

The term “generative artificial intelligence model” refers to a machine learning model that creates new data, such as choreography or music, based on input prompts and learned knowledge.

The term “original motion data” refers to data representing newly generated physical movement or dance choreography tailored to the user's information.

The term “acoustic data” refers to audio information, including music tracks or sound effects generated according to the user's input or preferences.

The term “data storage device” refers to an electronic memory or database system that stores datasets such as choreography patterns, music files, or user information.

The term “information processing terminal” refers to a computing device, such as a smartphone, tablet, or personal computer, used by the user to interact with the system.

The term “user interaction” refers to any input, operation, or response made by the user via the information processing terminal.

The term “body information acquisition device” refers to an apparatus, such as a wearable sensor or motion tracker, that collects biometric or movement-related data from the user's body.

The term “biometric motion information” refers to data that reflects the user's physical movements, posture, or activity as captured by sensors or cameras.

The term “analysis device” refers to a component or computing system that processes and evaluates collected data to extract relevant features or differences.

The term “difference information” refers to identified discrepancies between the generated motion data and the user's actual movement.

The term “user interface device” refers to hardware or software used to present information to the user or receive input from the user, such as screens, speakers, or haptic devices.

The term “guidance and feedback” refers to information, instructions, or corrections provided to the user to improve their dance performance.

The term “group-integrated motion performance” refers to a coordinated dance routine generated for multiple users participating as a group.

The term “individual motion parts” refers to unique sections or roles of choreography assigned to each group member.

The term “information analysis device” refers to a processing unit that evaluates and compares motion, biometric, or behavioral data for performance assessment.

The term “group motion evaluation” refers to the process of analyzing and judging the quality or synchronization of a group's dance performance.

The term “optimized feedback” refers to advice or guidance tailored based on analysis results to enhance both group and individual user performance.

### Embodiment for Implementing the Invention

The present invention may be implemented as a system including a server, an information processing terminal, and one or more body information acquisition devices such as wearable sensors.

The server may be realized by a general computing apparatus, such as a cloud-based computer or a local server running conventional server operating systems. The server may execute software platforms such as Python with frameworks including Flask or FastAPI for backend operations. Databases such as MySQL or PostgreSQL can be used to store various attribute information, preference information, user data, original motion data, acoustic data, and historical interactions.

The generative artificial intelligence model may be realized using machine learning frameworks such as TensorFlow or PyTorch on the server. The server utilizes these generative models to produce original motion data (choreography) and acoustic data (music or sound accompaniment) tailored to specific user requirements, given in the form of a prompt sentence.

The information processing terminal, which may be a smartphone, tablet, or personal computer, executes a specialized application, which receives user inputs, communicates with the server, displays dance videos and feedback, and collects user operation logs. The application software may be developed using technologies such as Swift (for iOS), Java/Kotlin (for Android), or web technologies (for PC).

One or more body information acquisition devices worn by the user, such as smartwatches, fitness bands, or IMU-based motion trackers, may be connected to the information processing terminal via Bluetooth Low Energy (BLE) or equivalent communication protocol. These devices transmit biometric motion information to the terminal in real time, such as acceleration, orientation, or posture data.

The user operates the application on the information processing terminal to input attribute information (such as age, physical condition, and skill level) and preference information (including desired dance style and music type). Representative examples of prompt sentences are as follows:

“Please create an intermediate-level jazz dance for people in their twenties, using an up-tempo track.”

“Please create a glamorous and energetic dance for a group of five people to perform at a wedding.”

The terminal transmits the entered information to the server, which generates a prompt sentence, queries the appropriate database, and causes the generative artificial intelligence model to generate choreography and music.

The generated original motion data and acoustic data are transmitted from the server to the information processing terminal, displayed to the user, and used during practice. During dance practice, the terminal collects real-time biometric motion information from the body information acquisition device and optionally records video via its built-in camera. These data are transmitted to the server.

The server analyzes the acquired motion and video data using motion analysis libraries such as OpenPose or MediaPipe and compares them with the reference original motion data. The server identifies differences between the user's movements and the model choreography, and generates specific guidance and feedback based on these differences.

The feedback, which may be textual, graphical, or via device haptics, is sent to the information processing terminal and ultimately communicated to the user through the interface or via body information acquisition device features such as vibration on specific body parts.

For group mode, each user submits individual attribute and preference information, and the server generates a group-integrated motion performance by distributing individual motion parts to each member. The biometric motion data of each member are collected, and the server provides both collective and individualized feedback to improve overall group performance.

This embodiment enables automated and tailored creation of dance content, real-time analysis, and AI-guided feedback, thereby making efficient and effective dance learning possible for both solo and group users, without the need for a human instructor.

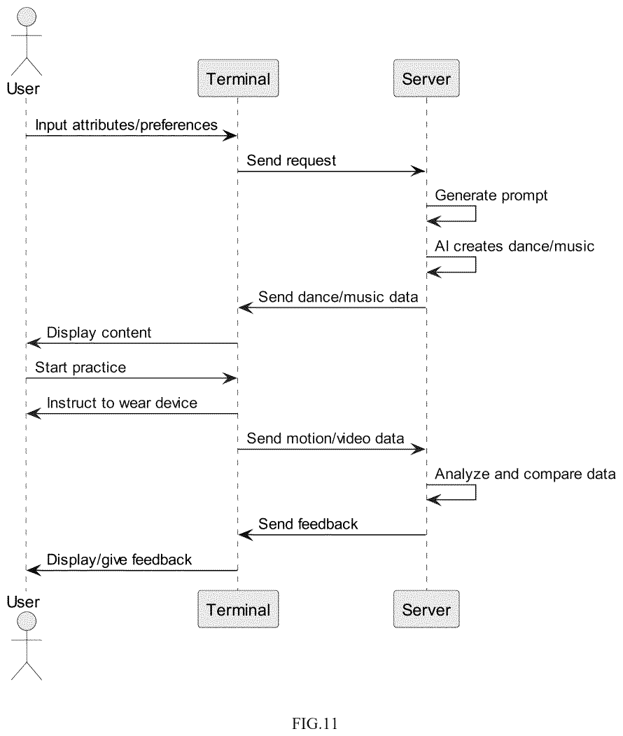

The following describes the processing flow using FIG. 11.

### Step 1:

The user launches the application on the information processing terminal and inputs attribute information and preference information, such as age, physical condition, dance style, skill level, and music preference, using the application interface.

Input: User's manual input of information via application interface.

Data processing: The terminal collects user input and prepares it in a structured data format.

Output: Structured user data is sent to the terminal's backend module.

### Step 2:

The terminal receives the structured user data, formats it into a request payload, and transmits it to the server over a secure communication channel, such as HTTPS.

Input: Structured user data from Step 1.

Data processing: The terminal performs any necessary encoding, such as formatting the data as JSON.

Output: A formatted request is transmitted to the server.

### Step 3:

The server receives the formatted user data and analyzes the content to extract relevant parameters for dance generation. The server generates a prompt sentence based on the input and queries a data storage device to retrieve related motion and acoustic data.

Input: Structured user data from the terminal.

Data processing: The server parses the data, constructs a prompt sentence, and retrieves reference data from the storage device.

Output: A prompt sentence and relevant dataset are prepared for AI model processing.

### Step 4:

The server provides the prompt sentence and the retrieved database content to a generative AI model. The generative AI model processes these inputs to generate original motion data (such as choreography representations) and acoustic data (such as original music).

Input: Prompt sentence and dataset from Step 3.

Data processing: The generative AI model synthesizes new motion and acoustic data based on the prompt and database knowledge.

Output: Generated original motion data and acoustic data.

### Step 5:

The server sends the generated original motion data and acoustic data to the information processing terminal.

Input: AI-generated motion and acoustic data.

Data processing: The server packages the generated data as appropriate for network transmission (such as video and audio streaming formats).

Output: Data packets containing original motion and acoustic data are sent to the terminal.

### Step 6:

The terminal receives the generated dance video and music, processes the files for display and playback, and presents them via the application's user interface.

Input: Generated video and music data from the server.

Data processing: The terminal decodes and buffers the files for smooth playback.

Output: The user views the dance video and listens to the music.

### Step 7:

The user prepares for practice by donning body information acquisition devices such as wearable sensors on required body parts (for example, wrists, ankles, and waist). The user selects the practice mode in the application and initiates playback of the generated content.

Input: Notification to wear devices and select practice mode.

Data processing: The user follows application instructions, physically prepares, and starts the practice session.

Output: The system is ready for motion data acquisition.

### Step 8:

The terminal establishes a connection with the wearable sensors and begins to collect real-time biometric motion information during the user's practice session. Optionally, the terminal activates its camera to record video of the user's movements.

Input: Biometric motion data and/or video stream from devices.

Data processing: The terminal synchronizes, encodes, and aggregates the sensor data and video.

Output: Collected biometric motion information and video data are prepared for transmission.

### Step 9:

The terminal transmits the collected biometric motion data and video data to the server for evaluation.

Input: Packaged motion data and video from Step 8.

Data processing: The terminal sends all necessary practice data to the server using secure network protocols.

Output: Data arrives at the server.

### Step 10:

The server analyzes the received motion and video data using analysis devices and algorithms such as OpenPose or MediaPipe, comparing the user's motion with the original motion data generated previously. The server identifies any discrepancies and determines necessary improvements.

Input: Biometric motion and video data.

Data processing: The server uses pose estimation and motion analysis to find differences and extract performance metrics.

Output: List of discrepancy points and improvement instructions.

### Step 11:

The server generates specific and actionable feedback based on the identified discrepancies, tailoring guidance to the user's needs. The server transmits this feedback to the terminal.

Input: List of detected issues from Step 10.

Data processing: The server formats feedback as readable instructions or signals for the terminal and possibly the wearables.

Output: Feedback messages are sent to the terminal.

### Step 12:

The terminal receives the feedback, displays it using the application's user interface as text or visual cues, and, as needed, sends commands to the wearable devices to provide haptic feedback (e.g., vibration on a wrist where movement correction is suggested).

Input: Feedback from the server.

Data processing: The terminal displays, sounds, or vibrates feedback to the user in real time.

Output: The user receives specific guidance for improvement.

### Step 13:

In group scenarios, each user repeats Steps 1 to 12, with the server additionally combining input from multiple users to generate coordinated, group-integrated motion data, allocate individual motion parts, and assess group performance. The server sends individualized and group feedback in a synchronized manner to all terminals.

Input: Group member attribute and preference data, and practice data from multiple users.

Data processing: The server generates group choreography, distributes roles, evaluates collective performance, and prepares synchronized multi-user feedback.

Output: Each terminal receives instructions and feedback tailored for its respective user within the group context.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional systems for generating movement patterns, operation instructions, or expressive actions for users or machines lack the ability to flexibly adapt to individual physical, environmental, or emotional parameters in real time. Furthermore, real-time feedback and optimization in response to the user's physiological or emotional conditions are insufficient, making it difficult to provide personalized control and guidance, especially in dynamic group contexts or when using wearable sensors for motion analysis and correction.

The specific processing by the specific processing unit 290 of the data processing device 12 in Application Example 1 is realized by the following means.

The present invention provides a server including a processor configured to acquire physical information, environmental information, attribute information, and preference information from a user; analyze the acquired information and input it to a generative artificial intelligence model to generate an operation pattern for a controlled device or expressive action; output the generated operation pattern and related information to output apparatus or terminals; further optimize the operation pattern using prompt sentences and real-time analysis; acquire biological or motion data from wearable devices; analyze and compare the data with the generated pattern to provide evaluation, guidance, adaptive and corrective feedback; estimate user emotion and adapt outputs accordingly; and, in the case of multiple users, generate group-integrated movement patterns and individualized feedback. This enables real-time personalization and optimization of operation patterns, expressive actions, and feedback according to individual or group state, behavior, and emotional condition, resulting in higher performance, safety, learning, and user satisfaction.

The term “physical information” refers to data representing measurable characteristics of a user's body, such as biometric data, movement data, position data, or physiological parameters obtained via sensors or input devices.

The term “environmental information” refers to data representing the physical or operational surroundings relevant to the device, user, or group, such as temperature, humidity, layout, noise level, lighting, or other context-dependent parameters.

The term “attribute information” refers to details describing inherent or assigned properties of a user or device, including but not limited to age, ability level, role, device type, or operational mode.

The term “preference information” refers to data indicating a user's selections, likes, interests, tendencies, or desired settings related to operation patterns, expressive actions, music, motion style, or feedback type.

The term “generative artificial intelligence model” refers to an artificial intelligence system, algorithm, or network capable of generating new outputs-such as operation patterns, movement sequences, or multimedia content-based on input data and learned patterns.

The term “operation pattern” refers to a structured sequence of commands, behaviors, movements, or actions executed by a controlled device, system, or user with the objective of achieving an intended task or expressive output.

The term “output apparatus” refers to any hardware system, device, or interface capable of presenting, displaying, actuating, or otherwise conveying generated operation patterns or related information to a user or controlled entity.

The term “terminal” refers to a user-operated hardware device, such as a smartphone, tablet, computer, or similar apparatus, capable of inputting or receiving data, displaying feedback, or facilitating interaction with the system.

The term “prompt sentence” refers to a structured input statement, query, or directive provided to a generative artificial intelligence model to guide or condition its output.

The term “measurement device” refers to hardware for capturing and transmitting data such as movement, biological state, or positional parameters, including wearable sensors, body-mounted trackers, or embedded bio-signal apparatus.

The term “evaluation information” refers to data or metrics generated by comparing actual measured activity or state with the expected or generated operation pattern, indicating performance quality or deviation.

The term “issues” refers to discrepancies, errors, inefficiencies, or performance deficits identified during comparison and analysis of actual state versus generated operation pattern.

The term “guidance” refers to information, instructions, or cues delivered to a user for the purpose of modifying, correcting, or improving their motion or behavior according to the intended outcome.

The term “adaptive feedback” refers to information or corrective instructions that are dynamically adjusted based on real-time analysis of user state, behavior, or performance relative to desired objectives.

The term “correction instruction” refers to a specific directive or cue that facilitates improvement or adjustment of operation patterns, motion, or system state.

The term “emotion estimation processing” refers to computational or analytic procedures for inferring or recognizing a user's emotional state based on sensor, physiological, behavioral, or contextual data.

The term “emotional state” refers to the detected or inferred psychological or affective condition of a user, such as happiness, frustration, engagement, or fatigue, as determined by the system.

The term “group-integrated operation pattern” refers to an operation or motion command sequence that is generated based on collective parameter data from multiple users and is optimized for coordinated execution by a group.

The term “feedback” refers to any information, evaluation, assessment, or recommendation provided to a user or controlled device for the purpose of enhancing performance, safety, or experience.

### Embodiment for Implementing the Invention

This invention can be realized by configuring a system including a server, one or more terminals, wearable measurement devices, and at least one output apparatus or controlled device. The system incorporates hardware such as servers (data processing apparatus), terminals (e.g., smartphone, tablet, or personal computer), wearable sensors (such as motion capture bands or physiological sensors), and output devices (such as robots, display screens, speakers, or actuators). The software stack includes a generative AI model implemented by frameworks such as TensorFlow or Keras, database management software, server-side scripts (for example, written in Python), and client applications for the terminals.

The server performs the core analysis and generation processes of the system. The server acquires user-specific physical information (such as body movements or biometric parameters obtained from wearable sensors), environmental information (such as temperature, humidity, or spatial layout received via terminal input or networked sensors), attribute information (such as age or role), and preference information (such as preferred motion style or music genre) from the terminal or measurement device. The server analyzes the acquired data and constructs a prompt sentence, which is input to the generative AI model to generate a context-sensitive operation pattern. The server subsequently distributes the generated operation pattern, which may be represented as a robot movement sequence, dance choreography, or other structured commands, to the terminal or output device. The server can further optimize the generated pattern by re-inputting updated prompt sentences, reflecting real-time changes and user feedback, to the generative AI model.

During operation, user terminals function as interfaces for data entry, feedback display, and coordination with external devices. The terminal can receive the generated pattern and present the corresponding information (such as instruction sequences, video, or audio) to the user via its graphical or audio output components. A measurement device, such as a wearable motion sensor or physiological tracker worn by the user, collects real-time motion data or biometric signals and transmits this data to the server via the terminal. The server analyzes the received measurement data by comparing it with the generated pattern and extracts evaluation information or identifies issues. Based on this analysis, the server produces adaptive feedback, guidance, or correction instructions, which may be delivered to the terminal in text, audio, graphical, or haptic form. In some embodiments, the server estimates the user's emotional state using emotion estimation methods and adjusts the output pattern or feedback in accordance with the detected emotion.

For multi-user or group applications, the server is configured to acquire parameter information from each member of the group and generate an operation pattern integrated for the group as a whole. The server can assign individualized roles or choreography to each member, analyze real-time measurement data from multiple users, and provide feedback or corrections tailored to both the group and each individual. All communications between system components may utilize standard communication protocols such as Wi-Fi, Bluetooth, or other networked connections.

As a specific example, a user wishing to generate and practice a personalized dance sequence launches an application on a tablet terminal, inputs their style preferences, mood, and age, and optionally wears motion-sensing bands on the wrists and ankles. The terminal relays the following prompt sentence to the server:

“Jazz dance style, happy mood, intermediate level, for people in their 20s, like up-tempo music.”

The server receives the input, utilises a generative AI model implemented with TensorFlow or Keras, and produces an original dance choreography paired with music that matches the user's intent. The terminal displays the generated sequence and plays the music. During practice, the wearable devices capture the user's motion data, which is transmitted to the server for real-time analysis. If a deficiency in movement or emotional engagement is detected, the server can provide specific feedback such as: “Bend your knees more during the chorus, and try to maintain a cheerful expression.”

In an industrial automation example, the user could input parameters such as:

“Factory temperature is 22° C., humidity is 40%, layout is TypeA, robot is arm type, medium speed, high precision.”

The server processes this prompt through its generative AI model to derive an optimized robot control sequence, which is dispatched to the robot as an operation pattern. It then analyzes robot sensor feedback, providing subsequent optimization and guidance as necessary.

Through this arrangement, the invention can dynamically generate, optimize, deliver, and refine operation patterns and feedback for users, controlled devices, or groups, based on physical, environmental, attribute, and preference data, as well as real-time measured or emotional information. This embodiment supports a wide range of practical applications—from personalized movement coaching to adaptive robotic control—by leveraging generative artificial intelligence models and interactive, sensor-driven system design.

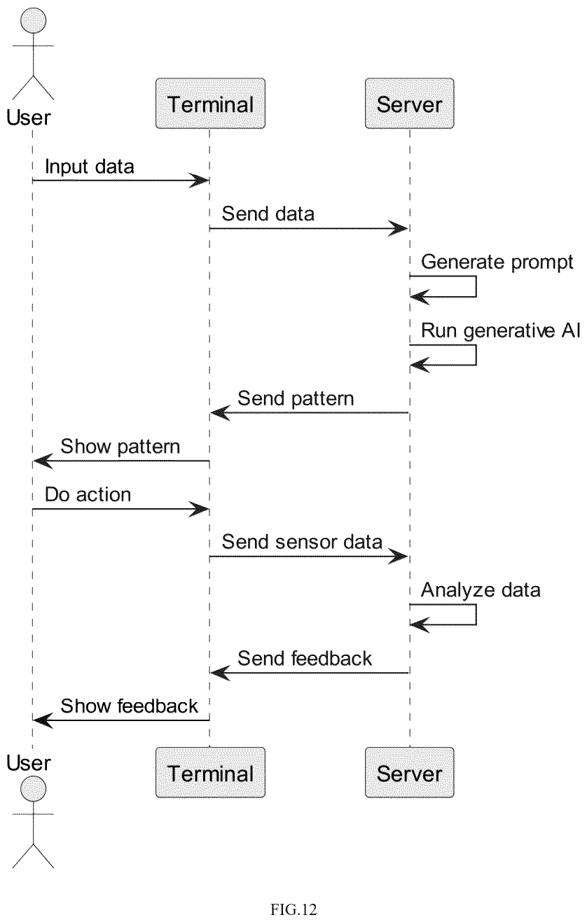

The following describes the processing flow using FIG. 12.

### Step 1:

The user operates the terminal and inputs relevant information such as physical characteristics, environmental parameters (e.g., temperature, layout), attribute data (e.g., age, ability), and preference data (e.g., style, mood, operational goals) through a graphical user interface. The input consists of structured text entries or selections. The output is a completed user profile or session data set stored within the terminal.

### Step 2:

The terminal collects the user's inputted data, formats it into a standardized digital structure (such as a JSON object), and transmits the formatted data packet to the server via a secure communication channel. The input is the user profile or session data; the output is the data packet delivered to the server.

### Step 3:

The server receives the data packet from the terminal and parses each field to extract relevant parameters. The server generates a prompt sentence representing the session context by concatenating or mapping the extracted parameters into natural language or structured prompt text. The input is the received user data packet; the output is a prompt sentence formulated for AI model input.

### Step 4:

The server inputs the prompt sentence and any auxiliary data into the generative AI model implemented with frameworks such as TensorFlow or Keras. The generative AI model processes the prompt, performs inference based on internal algorithms and learned parameters, and generates an operation pattern or content (e.g., robot movement sequence, choreography, music). The input is the prompt sentence and context data; the output is the generated operation pattern or multimedia content.

### Step 5:

The server formats the generated operation pattern or content for compatibility with the output apparatus (such as robots, displays, or terminals) and transmits the formatted output to the appropriate devices over the network. The input is the operation pattern or content generated by the AI model; the output is device-specific command data or media files delivered to the output apparatus.

### Step 6:

The output apparatus (such as the terminal for users or a controlled device for robots) receives the command data or content. The terminal displays instructions, video, or music to the user, or the robot executes physical actions as specified. The input is the device command data or media files; the output is an observable user experience or robotic action.

### Step 7:

The user or device executes actions according to the pattern—for example, the user practices dance movements shown on video, or the robot performs assigned operational motions. The user may wear measurement devices, such as motion sensors, which collect real-time performance or biometric data. The input is the pattern or instruction; the output is action performed and associated sensory data.

### Step 8:

The terminal or output apparatus collects real-time measurement data (e.g., motion, biometric, or emotional data from sensors or cameras), and transmits this data to the server for evaluation. The input is real-time sensory or measurement data; the output is a data packet sent to the server.

### Step 9:

The server receives measurement data, analyzes it by comparing against the original operation pattern, and computes evaluation results such as accuracy, timing, or user state. The server may also perform emotion estimation if applicable. Based on this analysis, the server generates feedback messages, guidance, or correction instructions. The input is measurement and sensor data plus reference pattern; the output is feedback or revised operational guidance.

### Step 10:

The server transmits the feedback or correction instructions to the terminal, output apparatus, or measurement device. The terminal presents real-time guidance or alerts to the user via text, audio, graphical overlays, or haptic feedback (such as vibration from wearables). The input is the feedback data from the server; the output is corrective information or adaptation experienced by the user or system, helping to refine future actions.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional dance generation and practice support systems are insufficient in flexibly reflecting individual preferences and emotional states of users, often providing personalized content and feedback that do not optimally match the user's actual condition or intent. Real-time adaptation during practice, including movement correction and coaching, especially based on the user's emotional state, is lacking. In addition, when generating group dance performances, these systems fail to efficiently coordinate both the collective choreography of the group and the unique characteristics or preferences of each individual member. There is also an absence of a mechanism for integrating real-time motion data acquisition with emotional analysis to enhance user engagement and improve practice outcomes.

The specific processing by the specific processing unit 290 of the data processing device 12 in Example 2 is realized by the following means.

The present invention provides a server including a processor configured to receive information regarding movement style, age group, physical ability, personal preference, and emotional state from a user, analyze the received information, issue a generation instruction sentence to a generative artificial intelligence model, generate personalized motion video and audio information, and transmit the generated content to a user terminal. The processor is further configured to acquire sequential motion information from an information acquisition device worn by the user, compare the acquired motion data with the generated reference content, analyze emotional state using an emotion estimation device, and generate advisory and evaluation information based on these analyses. The system also allows for integrated group choreography generation and individualized assignment for multiple users, as well as real-time group performance and emotional analysis using artificial intelligence and emotion estimation. This enables the creation, delivery, and adaptive feedback of motion- and emotion-aware content that supports effective, personalized, and emotionally-responsive dance practice and group performance enhancement.

The term “movement style” refers to the type or genre of physical motion or choreography desired by the user, including but not limited to specific dance genres, movement techniques, or performance aesthetics.

The term “age group” refers to a classification of users according to their chronological age, which may influence appropriate movement difficulty, choreography style, and content suitability.

The term “physical ability” refers to the user's bodily capabilities, including endurance, strength, flexibility, and overall fitness level, which are used to tailor movement difficulty and choreography complexity.

The term “personal preference” refers to the individual user's likes, interests, and tastes, such as preferred music style, dance genre, or aesthetic elements.

The term “emotional state” refers to the affective or psychological condition of the user at a given time, including emotions such as happiness, sadness, excitement, frustration, or relaxation.

The term “user terminal” refers to an information processing device operated by the user, such as a smartphone, tablet, or personal computer, which is capable of transmitting, receiving, and displaying data and content.

The term “information acquisition device” refers to a sensor-equipped device worn by the user, such as a wearable device or smart sensor, capable of acquiring real-time motion and/or physiological data.

The term “generation instruction sentence” refers to a prompt or directive formulated from user information and provided to a generative artificial intelligence model in order to produce personalized content.

The term “generative artificial intelligence model” refers to an artificial intelligence system or algorithm capable of generating original data, such as movement videos or audio content, based on provided input instructions.

The term “motion information stored in a storage device” refers to a collection of digital records, held in any suitable data storage system, representing reference movement patterns, choreography data, or performance samples.

The term “emotion estimation device” refers to a hardware or software module capable of analyzing physiological or behavioral data to estimate the affective state or emotion of the user.

The term “personalized motion video and audio information” refers to movement and music or sound content generated by the system in accordance with the individual preferences, physical ability, and emotional state of the user.

The term “advisory information and evaluation information” refers to feedback or guidance produced by the system for the user's benefit, including corrective instructions, performance evaluation, and motivational suggestions.

The term “group motion expression” refers to a coordinated movement or choreography generated for a plurality of users, taking into account collective input and synchronization.

The term “individual movement roles” refers to unique choreography parts or assigned sections of movement that are designated to each user in a group performance.

The term “sequential motion information” refers to time-series data representing the movement of the user or users, typically collected continuously or repeatedly during a practice session.

One embodiment of the present invention concerns a system for the creation and adaptive coaching of individualized and group movement expressions, utilizing advanced information processing, artificial intelligence, and emotion estimation technologies.

In this embodiment, the server, functioning as the central processor, is implemented on a computing device such as a cloud server or local workstation equipped with sufficient computational resources. The user terminal may be a smartphone, tablet, or personal computer running a dedicated application, while the information acquisition device may be a wearable sensor or a smart device capable of capturing motion data, such as a smartwatch or a fitness tracker. The system also incorporates a data storage device for storing reference motion patterns and a generative artificial intelligence model trained to produce movement videos and audio content. An emotion estimation device, implemented as a software module (for example, using a deep neural network such as BERT or a custom emotion analysis engine), is included for real-time emotional state detection.

The user initiates the process by starting the application on the user terminal and providing personal information such as desired movement style, age group, physical ability, personal preference, and emotional state through a natural language input interface. The terminal structures this information and securely transmits it to the server. The server analyzes the received data, accesses the motion information stored in the storage device, and composes a suitable prompt sentence, or generation instruction, for the generative AI model.

The server uses the generative AI model (for example, a fine-tuned large language model or a generative music/video AI engine) to produce personalized motion video and matching audio content in accordance with the prompt. A typical prompt sentence may be:
“Generate a video of an energetic, fun jazz dance suited for people in their 20s, intermediate level, expressing happy emotions, with synchronized music.”

The generated movement video and audio are transmitted from the server to the user terminal where they are presented to the user for review and practice.

For real-time movement evaluation and coaching, the user attaches the information acquisition device (such as a smartwatch or other wearable) and performs the movement or dance routine while the user terminal synchronizes wearable data with the display of the generated content. The terminal collects sequential motion information, including time-series sensor data such as acceleration, rotation, and positioning, as well as, optionally, video data from an embedded camera. This data is transmitted to the server in real time.

On the server side, the collected user motion information is analyzed by motion recognition software, such as OpenPose or MediaPipe, to extract keypoints and compare the user's actual movements to the generated reference choreography. The emotion estimation device processes relevant sensory or video data to estimate the user's current emotional state. Based on both motion discrepancy analysis and emotional assessment, the server generates personalized advisory and evaluation information. This feedback may include instructions, corrections, motivational messages, or progress evaluations, and is transmitted to the user terminal for immediate presentation. For example, if the system detects the user is lagging in timing while expressing signs of frustration, the feedback may be:
“You're doing great! Try to relax your shoulders and focus on the rhythm.”

In a group choreography embodiment, each user terminal receives and transmits the respective member's personal and emotional information to the server. The server aggregates group data, forms an integrated group motion expression using the generative AI model, and assigns distinct individual roles to each group member. Each member's device collects and transmits motion information during practice sessions, and the server conducts performance analysis not only for each individual but for the group as a whole. Feedback, such as “Work on matching arm movements at 1:10 in the chorus,” is generated and sent to all relevant terminals.

In this manner, the server, user terminals, wearable or smart devices, data storage, generative AI model, and emotion estimation engines work in concert to enable a comprehensive, adaptive, and emotionally sensitive system for movement and dance generation, evaluation, and improvement.

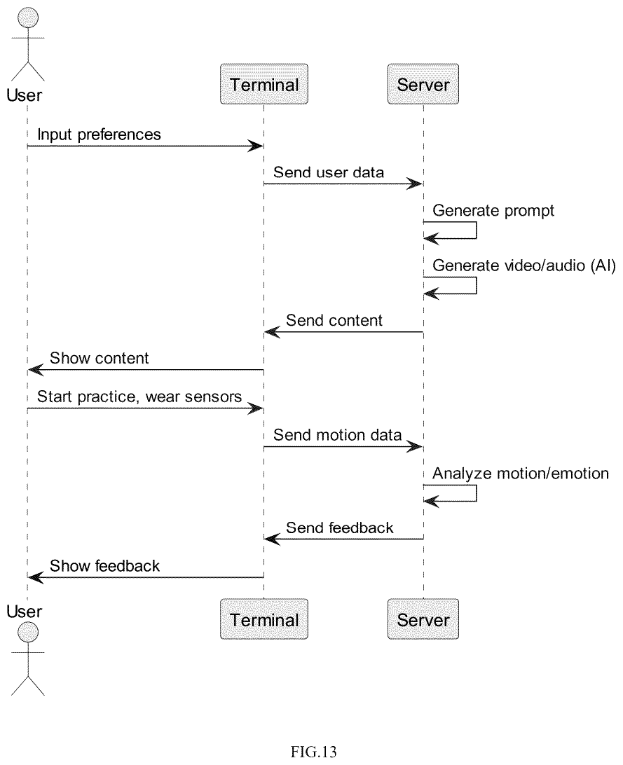

The following describes the processing flow using FIG. 13.

### Step 1:

The user launches the application on the user terminal and enters personal information such as movement style, age group, physical ability, personal preference, and emotional state into the provided input interface. The input is a text prompt created by the user, and the output is the collection of these parameters by the application.

### Step 2:

The terminal receives the user's input, parses the text to extract relevant data fields, and structures the information into a standardized digital format, such as a JSON object. The input is the user's raw natural language text, and the output is the organized data ready for transmission.

### Step 3:

The terminal transmits the formatted user data to the server via a secure communication protocol (for example, HTTPS). The input is the structured data object, and the output is the successful data transfer over the network.

### Step 4:

The server receives the structured user data and performs validation to ensure all required fields are present and correct. The input is the formatted user data, and the output is validated user parameters for further processing.

### Step 5:

The server accesses the motion information stored in its storage device and generates a prompt sentence for the generative AI model based on the validated user parameters. The server then submits this prompt to the generative AI model to generate personalized motion video and audio content. The input is the validated user data combined with stored motion data; the data is processed to consolidate a prompt sentence, and the output is generated movement video and audio.

### Step 6:

The server transmits the generated personalized motion video and audio files to the user terminal, accompanied by any necessary metadata. The input is the created content and metadata, and the output is the content sent to the terminal.

### Step 7:

The terminal receives the personalized content from the server and plays the motion video and audio for the user within the application interface. The input is the received content, and the output is visual and audio presentation to the user.

### Step 8:

The user attaches the information acquisition device, such as a wearable sensor, and performs the instructed movement or dance routine in front of the terminal. The input is the guidance received via the terminal, and the output is the user-generated live motion.

### Step 9:

The terminal acquires sequential motion data and, optionally, video data from the wearables and built-in camera during the user's activity, synchronizes the data with the presented content, and prepares the collected information for transmission. The input is real-time signals from sensors and camera, and the output is the packaged motion and video data.

### Step 10:

The terminal transmits the collected motion and optional video data to the server for analysis. The input is the prepared sensor and video data, and the output is the successful data upload to the server.

### Step 11:

The server analyzes the real-time motion and video data using motion recognition software, such as OpenPose or MediaPipe, to extract key movement features and compare them with the reference generated choreography. Simultaneously, the server uses the emotion estimation engine to process physiological and/or visual data to estimate the user's current emotional state. The input is the user's activity and emotion data, and the output is analysis results detailing discrepancies and emotional evaluation.

### Step 12:

The server generates advisory information and evaluation feedback, including specific movement corrections and motivational or emotional guidance, based on the comparative and emotional analysis. The server prepares this feedback for delivery. The input is the analysis results, and the output is the feedback content.

### Step 13:

The server transmits the feedback and any annotated visuals to the user terminal for immediate user presentation. The input is the feedback messages and data, and the output is their successful delivery to the terminal.

### Step 14:

The terminal displays the received feedback to the user in real-time through the application interface and, if available, utilizes the information acquisition device (such as through vibration) to guide user motion corrections. The input is the feedback content, and the output is real-time user guidance and correction support.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional systems for dance practice and movement instruction do not adequately address the individual differences in user preference, physical capability, and emotional state. These systems lack the capacity to generate personalized movement routines and audio data in real time, or to analyze users' emotional conditions and motion performance dynamically. Furthermore, in group scenarios, existing systems have limited means to analyze and support collective performance and emotional well-being, as well as to provide individually assigned instruction and adaptive feedback based on real-time motion data from wearable devices.

The specific processing by the specific processing unit 290 of the data processing device 12 in Application Example 2 is realized by the following means.

The present invention provides a server including means for receiving user information including physical movement style, age, physical capability, preference, and emotional state; analyzing the received information using a motion information storage facility and a generative artificial intelligence model; generating customized motion video data and audio data; transmitting the generated data to user terminal devices; receiving real-time physical motion data from wearable devices; analyzing both individual and group motion performance; and generating and delivering adaptive instructional and emotional feedback to individual users and groups. This enables the provision of highly personalized, real-time movement instruction and emotional support in both individual and group practice settings, thereby offering enhanced learning efficiency and user engagement.

The term “physical movement style” refers to information indicating the specific type or category of body movement or dance preferred or performed by the user.

The term “age information” refers to data specifying the chronological age of the user.

The term “physical ability information” refers to data describing the level of physical fitness, endurance, or capability possessed by the user.

The term “preference information” refers to information concerning the user's individual likes, dislikes, or tendencies regarding music, atmosphere, or other elements relevant to the movement activity.

The term “emotional state information” refers to data indicating the current mood or affective condition experienced by the user.

The term “terminal device” refers to an electronic apparatus, such as a smartphone, tablet, or personal computer, that the user operates to interact with the system.

The term “motion information storage device” refers to a data storage apparatus or database that stores movement or dance-related data and example patterns for use in generating original content.

The term “generative artificial intelligence model” refers to a machine learning model that creates original motion video data and audio data based on input parameters.

The term “motion video data” refers to digital video files that depict dance or other physical movements generated by the system.

The term “audio data” refers to digital files representing accompanying music or sound, generated or selected in accordance with the user's physical movement style and preference information.

The term “communication device” refers to a hardware or software component that facilitates data exchange between the server and the terminal device.

The term “emotional state analysis device” refers to a computational unit or software module that processes user input or biometric data to estimate and interpret the user's emotional state.

The term “feedback information” refers to instructional or advisory data provided to the user based on motion analysis and emotional state assessment.

The term “biometric information acquisition device” refers to a sensor-equipped wearable apparatus that collects physiological and movement data from a user's body in real time.

The term “motion analysis processing device” refers to a software or hardware unit that extracts and analyzes motion features from biometric and video data.

The term “assignment information” refers to data indicating the portion or role assigned to each user within a group movement or dance routine.

The term “group motion video data” refers to synthesized video data representing a collective or synchronized movement performance generated for multiple users.

The term “time-series data” refers to data consisting of sequences of values captured at successive time intervals, often used to track changes in motion or biometric signals.

An embodiment for implementing the invention will be described below.

The system comprises a server, one or more terminal devices (such as smartphones, tablets, or personal computers), motion and biometric information acquisition devices (such as wearable sensors), and communication means for connecting these components. The server includes or is linked to a motion information storage device (for example, a database storing various dance or movement patterns), a generative artificial intelligence model for producing original motion video and audio data (for example, utilizing a machine learning model such as a deep neural network or transformer-based model), and an emotional state analysis device (which may be implemented using a machine learning classifier or rules-based analysis engine).

The user operates a terminal device installed with an application. Through this application, the user enters detailed information including physical movement style, age, physical ability, preferences (such as preferred music or movement atmosphere), and emotional state. The terminal device may validate and format this information into a prompt sentence such as:
Preferred Dance Style: Hip-hop
Current Emotion: Happy
Dance Level: Intermediate
Age: 25
Preference: Up-tempo music

The terminal transmits this information to the server via a secure communication protocol, for example, HTTPS.

The server receives and interprets the data, referencing the motion information storage device and generating custom motion video data and associated audio data using the generative artificial intelligence model. The server then transmits these generated files to the terminal device. The generated motion video is typically in a commonly supported digital video format (such as MP4), and the generated audio is in a format such as MP3 or WAV. The terminal device allows the user to view and practice with these custom routines and music, supporting playback functionality.

During practice, the user wears one or more biometric or motion information acquisition devices, which may include sensor-equipped wearables such as inertial measurement units (IMUs), smart bands, or motion-capture clothing. These devices collect data including body joint angles, acceleration, gyroscope data, and optionally physiological parameters such as heart rate. The terminal device aggregates this data, synchronizes it with real-time video recorded using a built-in camera of the terminal device, and transmits the combined data to the server.

The server uses software such as pose estimation libraries (for example, OpenPose or MediaPipe), to extract skeletal and kinematic information from the video. The server compares the live user data and video to the generated reference motion video, identifies deviations, and analyzes performance and technique. At the same time, the emotional state analysis device processes user input or physiological parameters to estimate the user's emotional condition in real time.

Based on this analysis, the server generates feedback information, which may include motion correction suggestions (“Raise your right arm higher during the spin!”) and motivational or emotional support messages (“Relax and enjoy the rhythm!”). The terminal device receives and displays this feedback to the user through on-screen messages, audio playback, or visual overlays.

In case of group practice, each user inputs their information and the terminal devices send individual profiles to the server. The server then generates an integrated group movement routine and divides the routine into parts for each user, distributing the assignments accordingly. During the group session, each user's motion and biometric data are collected and analyzed individually and collectively, and feedback is provided to both the group and each user.

Specific hardware that may be used in this embodiment includes, but is not limited to:
Terminal device: general-purpose computation devices such as smartphones, tablets, or PCs.
Biometric information acquisition device: wearable sensor modules including IMUs, smartwatches, fitness bands, or dedicated motion capture systems.
Server hardware: cloud servers or dedicated computers with sufficient computational resources to support artificial intelligence processing.
Communication means: standard wireless or wired networking, such as Wi-Fi, Bluetooth, or Ethernet.

Software examples include:
A custom application for the terminal device for data entry, playback, and communication.
A database management system (such as PostgreSQL or MongoDB) for storing and indexing movement patterns.
Generative machine learning models (that may be implemented with frameworks such as TensorFlow or PyTorch).
Pose estimation libraries (such as OpenPose, MediaPipe), and emotional analytics modules implemented as neural network classifiers or rule-based systems.

This embodiment realizes a system in which movement learning, motion-capture analysis, emotional support, and group collaboration are all adaptively personalized, enabling the user to efficiently improve physical and expressive skills as well as emotional well-being during practice sessions.

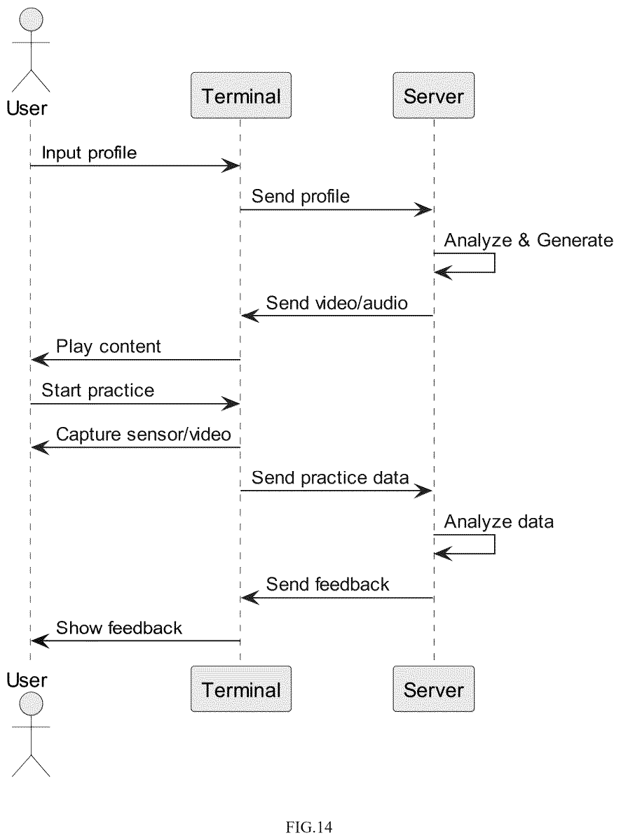

The following describes the processing flow using FIG. 14.

### Step 1:

The user launches the application on the terminal device and manually inputs their physical movement style, age information, physical ability information, preference information, and current emotional state into the provided fields. The terminal device validates the entries for completeness and consistency.

Input: User-entered data (e.g., “Preferred Dance Style: Hip-hop; Current Emotion: Happy; Dance Level: Intermediate; Age: 25; Preference: Up-tempo music”)

Output: Formatted prompt sentence and structured data package

### Step 2:

The terminal device transmits the formatted prompt sentence and structured data package to the server via a communication network (e.g., HTTPS).

Input: Formatted user data

Output: Transmitted data to the server

### Step 3:

The server receives the user data package and parses the prompt sentence. The server analyzes the data to extract relevant parameters for dance generation and emotional state evaluation.

Input: Received user prompt sentence and structured data

Output: Extracted user parameters

### Step 4:

The server queries a motion information storage device to retrieve relevant existing movement patterns, and then uses a generative AI model to generate customized motion video data and audio data based on the extracted user parameters.

Input: User parameters, motion database

Processing: Search and selection of relevant dance elements, generative AI modeling

Output: Original motion video data (e.g., MP4) and audio data (e.g., MP3)

### Step 5:

The server transmits the generated motion video data and audio data to the terminal device via a secure transmission protocol.

Input: Generated video and audio files

Output: Transmitted video and audio data to the terminal

### Step 6:

The terminal device receives the video and audio files, stores them locally, and automatically provides playback for the user to review and practice.

Input: Received video and audio files

Output: Local files stored and available for user interaction

### Step 7:

During practice, the user attaches wearable biometric information acquisition devices. The terminal device establishes connection with these devices and collects real-time biometric and motion data (such as joint angles, accelerations, and heart rate). The terminal device may also record video of the user's performance.

Input: Motion sensor readings, physiological data, and optional video

Output: Aggregated time-stamped biometric and video data

### Step 8:

The terminal device transmits the acquired biometric and video data to the server for analysis.

Input: Aggregated biometric and video data

Output: Data sent to the server

### Step 9:

The server analyzes the received biometric and video data using pose estimation software and compares the results with the reference motion video data generated earlier. The server identifies discrepancies in performance, such as out-of-sync movements or incorrect angles, as well as interpreting the user's emotional state using the emotional state analysis device.

Input: Biometric and video data, reference motion data

Processing: Pose estimation, deviation analysis, emotional analysis

Output: Identified discrepancies, performance metrics, and evaluated emotional state

### Step 10:

The server generates personalized feedback and guidance for the user, consisting of both corrective movement suggestions (“Raise your hips during the chorus”) and supportive messages as needed (“Relax and enjoy the rhythm!”).

Input: Identified discrepancies and emotional state

Output: Feedback and guidance messages

### Step 11:

The terminal device displays the received feedback to the user via on-screen notifications, highlights on playback, or audio messages using text-to-speech. The user can use this feedback to adjust performance in subsequent practice sessions.

Input: Feedback and guidance messages

Output: User instructions and highlighted content for improved training

### Step 12:

For group practice, each user repeats Steps 1 to 11 individually. The server then synthesizes integrated group performance data, generates a collaborative motion routine, assigns parts to each user, and provides both group and user-specific feedback during practice sessions.

Input: Individual user profiles, biometric data from multiple users

Processing: Group choreography synthesis, assignment, group evaluation

Output: Collaborative motion data and group feedback

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

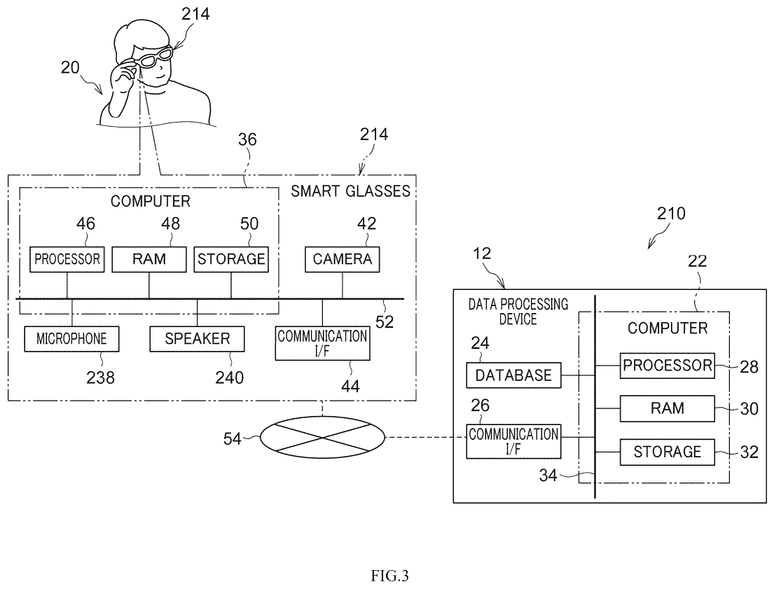

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

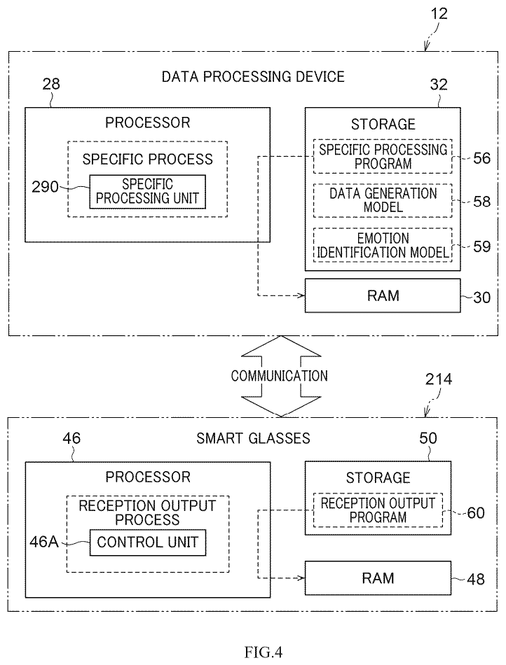

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

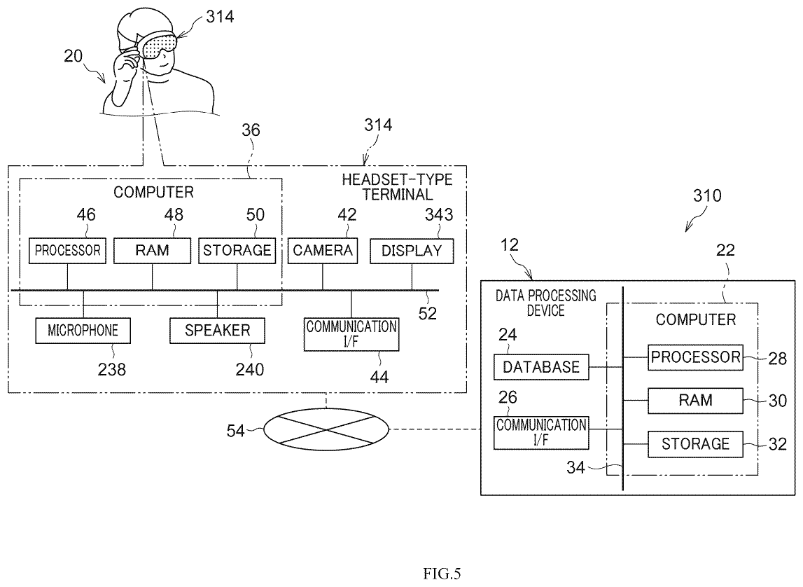

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

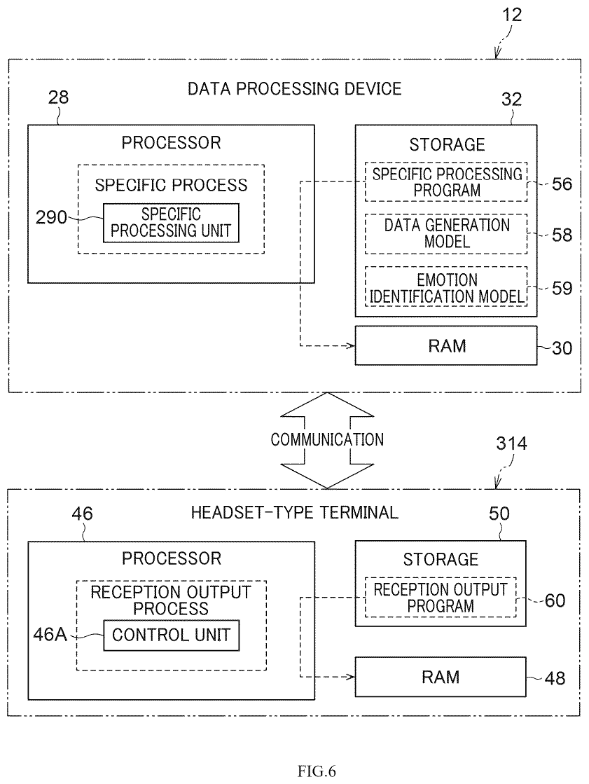

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

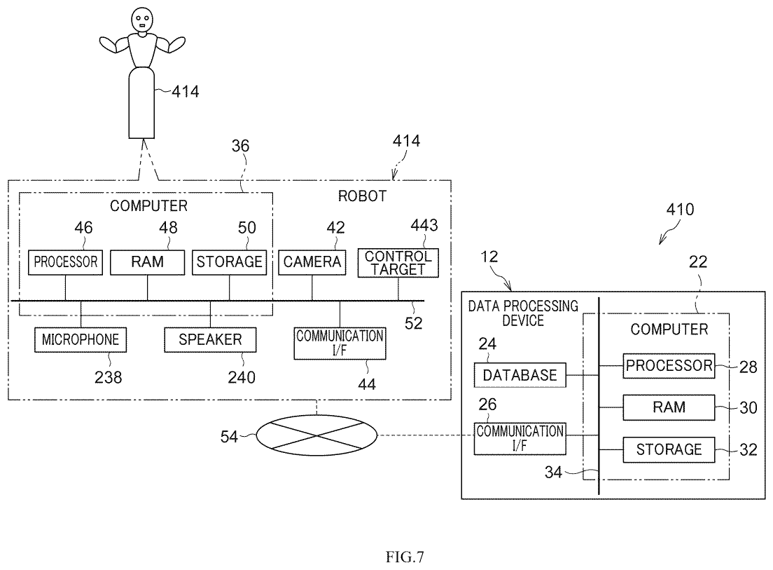

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

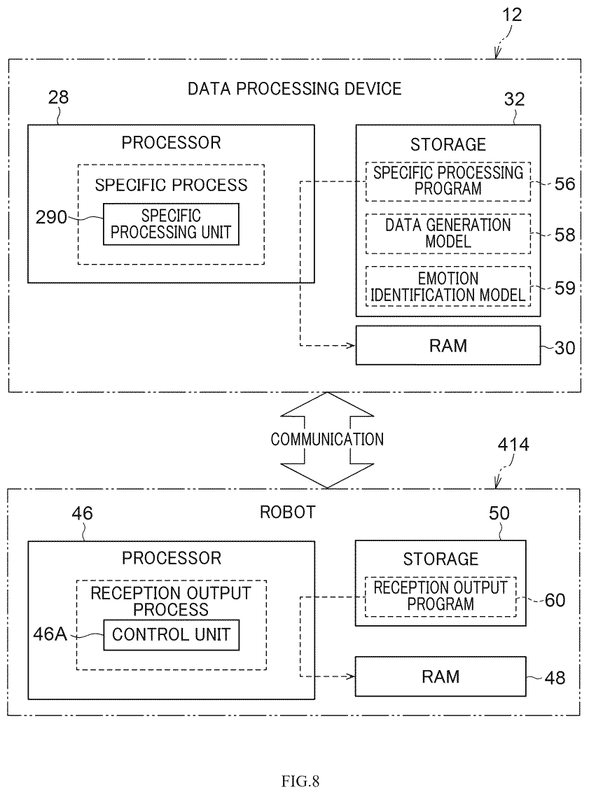

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

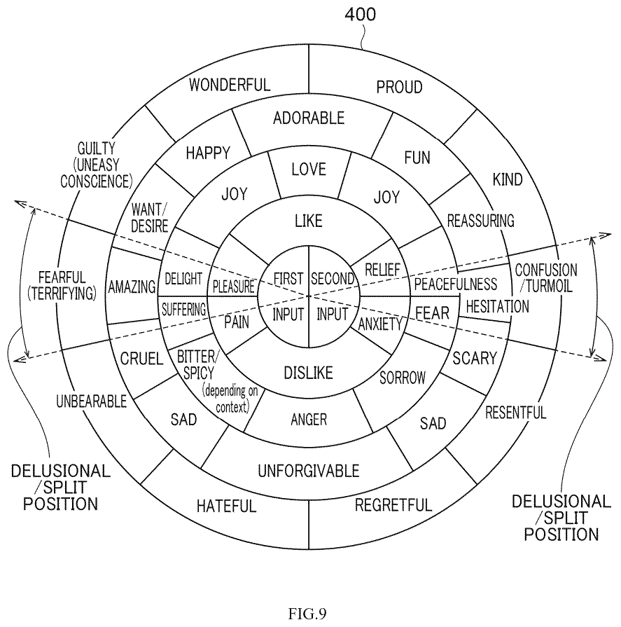

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

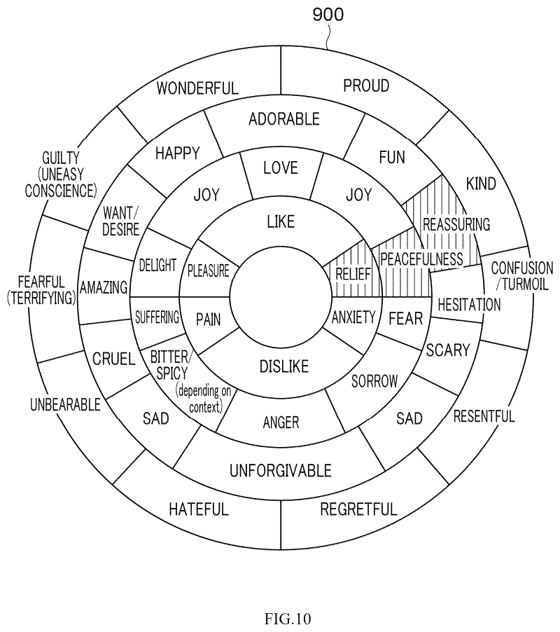

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system including a processor,
wherein the processor is configured to
receive attribute information and preference information from a user,
generate a prompt sentence based on the attribute information and the preference information,
generate original motion data and acoustic data using a generative artificial intelligence model based on the prompt sentence and data stored in a data storage device,
transmit the generated original motion data and acoustic data to an information processing terminal via a data communication device, and
record user interaction obtained from the information processing terminal.

### (Supplementary 2)

The system according to supplementary 1,
wherein the processor is configured to
obtain biometric motion information in real time from a body information acquisition device worn by the user,
analyze the obtained biometric motion information and video information using an analysis device to specify difference information by comparing with the generated original motion data, and
provide specific guidance and feedback to the user using a user interface device and the body information acquisition device based on the difference information.

### (Supplementary 3)

The system according to supplementary 1,
wherein the processor is configured to
receive attribute information and preference information from a plurality of users and generate a group-integrated motion performance,
allocate individual motion parts to each user using a generative artificial intelligence model,
obtain biometric motion information of each group member from the body information acquisition device and the information processing terminal and perform group motion evaluation using an information analysis device, and
provide optimized feedback to both the group and individual members based on results of the group motion evaluation.

### Application Example 1

### (Supplementary 1)

A system including a processor,
wherein the processor is configured to
acquire physical information, environmental information, attribute information, and preference information from a user,
analyze the acquired information and input the analysis result to a generative artificial intelligence model to generate an operation pattern related to a controlled device or an expressive action,
output the generated operation pattern to an output apparatus,
perform optimization of the operation pattern based on a prompt sentence input to the generative artificial intelligence model and an analysis result in the output process of the generated operation pattern, and
distribute the generated operation pattern and related information to a terminal.

### (Supplementary 2)

The system according to supplementary 1,
wherein the processor is configured to
acquire biological state data or motion data through a measurement device attachable to the user,
analyze the acquired data and extract evaluation information or issues by comparing with the generated operation pattern,
provide guidance, adaptive feedback, and correction instructions to the user based on the evaluation information or issues,
induce correction of the user's motion in real time through the measurement device during execution of the operation pattern, and
perform emotion estimation processing during analysis and automatically adjust feedback or the operation pattern according to the user's emotional state.

### (Supplementary 3)

The system according to supplementary 1,
wherein the processor is configured to
acquire individual or group physical information, environmental information, attribute information, and preference information from a plurality of users, and integrally generate an operation pattern corresponding to the group,
assign individual movement parts to the group or each member,
analyze real-time motion data acquired from each member, evaluate performance of the entire group and individual members, and generate feedback,
estimate group or individual emotion information, and provide feedback or operation pattern correction corresponding to each emotional state, and
provide the feedback or correction instructions to the terminal or the measurement device.

### Example 2

### (Supplementary 1)

A system including a processor,
wherein the processor is configured to
receive information regarding movement style, age group, physical ability, personal preference, and emotional state from a user,
analyze the received information, provide a generation instruction sentence to a generative artificial intelligence model based on motion information stored in a storage device, and generate personalized motion video and audio information, and
transmit the generated personalized motion video and audio information to a user terminal.

### (Supplementary 2)

The system according to supplementary 1,
wherein the processor is configured to
acquire sequential motion information via an information acquisition device worn by the user,
analyze the acquired motion information and identify movement differences by comparing the acquired motion information with the generated personalized motion video,
utilize an emotion estimation device to analyze the user's emotional state and generate advisory information and evaluation information for the user based on the identified movement differences and emotional state, and
provide the advisory information and evaluation information to the user via the user terminal and guide the user to correct their movement by using the information acquisition device.

### (Supplementary 3)

The system according to supplementary 1,
wherein the processor is configured to
receive individual movement style, personal preference, and emotional state information from a plurality of users and generate an integrated group motion expression,
assign individual movement roles to each group member,
acquire sequential motion information for each group member and analyze group motion expression, and
use the generative artificial intelligence model and emotion estimation device to generate advisory information and evaluation information for the group as a whole and for each member to support improvement of group motion expression.

### Application Example 2

### (Supplementary 1)

A system including a processor,
wherein the processor is configured to
receive information relating to a physical movement style, age information, physical ability information, preference information, and emotional state information from a user through a terminal device;
analyze the received user information and generate motion video data and audio data corresponding to the user information based on a motion information storage device and a generative artificial intelligence model;
transmit the generated motion video data and audio data to the terminal device via a communication device;
analyze the emotional state of the user based on input information or biometric measurement data using an emotional state analysis device, and generate feedback information based on the analysis result.

### (Supplementary 2)

The system according to supplementary 1,
wherein the processor is configured to
acquire biometric motion data of the user as time-series data through a biometric information acquisition device worn by the user;
extract motion feature quantities from the acquired biometric motion data and visible video data using a motion analysis processing device, compare the extracted motion feature quantities with the generated motion video data, and identify difference portions;
generate guidance content and feedback information for the user based on the identified difference portions and the result of the emotional state analysis, and present the information on the terminal device;
guide and instruct the user in real time through the biometric information acquisition device or through the terminal device for correction of physical movement.

### (Supplementary 3)

The system according to supplementary 1,
wherein the processor is configured to
receive, from a plurality of users, individual physical movement style information, preference information, and emotional state information, and generate integrated group motion video data and audio data for the group;
generate assignment information of movement portions corresponding to each user and individually deliver the assignment information;
collect physical motion data of each user in real time using a plurality of biometric information acquisition devices, evaluate group or individual motion performance; and
provide feedback information to the group and each user to support improvement of group motion skill and emotional state.

What is claimed is:

1. A system comprising a processor, wherein the processor is configured to
receive information regarding a dance style, age, physical ability, and preference from a user,
analyze the received information and generate an original dance video and music based on an existing dance database, and
transmit the generated original dance video and music to a user terminal.

2. The system of claim 1, wherein the processor is further configured to
acquire real-time motion data through a wearable device worn by the user,
analyze the acquired motion data and identify problems by comparing with the generated original dance video,
provide guidance and feedback to the user based on the identified problems, and
guide correction of the user's movements through the wearable device.

3. The system of claim 1, wherein the processor is further configured to receive individual dance styles and preference information from a plurality of users and generate an integrated group dance performance,
assign individual choreography parts to each member,
acquire real-time motion data from each member and analyze the overall performance of the group, and
provide feedback to the group as a whole and to individual members to assist in performance improvement.
